(19) United States
(12) Patent Application Publication
(10) Pub. No.: US 2018/0140136 A1
(43) Pub. Date: May 24, 2018

(54) Oil barrel and electric fryer having the same

(71) Applicant: X.J. ELECTRONICS (SHENZHEN) CO., LTD, Shenzhen (CN)

(72) Inventor: Yun PAN, Shenzhen (CN)

(21) Appl. No.: 15/385,754

(22) Filed: Dec. 20, 2016

(30) Foreign Application Priority Data
Nov. 22, 2016 (CN) 201611050665.9

(51) Int. Cl. A47J 37/12

(52) U.S. Cl. CPC A47J 37/1266; A47J 37/1219; A47J 37/128; A47J 37/1271

(57) ABSTRACT

The present invention belongs to the field of food processing, and particularly to an oil barrel and an electric fryer having the same; wherein, the oil barrel comprises an outer shell shaped as a barrel, an inner shell shaped as a barrel, disposed in a barrel cavity of the outer shell, and having a distance from the outer shell, and a shell connector configured to connect the outer shell with the inner shell and connected between a lip edge of the outer shell and a lip edge of the inner shell; the outer shell, the inner shell and the shell connector cooperatively define a thermal insulation chamber; the outer shell of the oil barrel is provided with a vacuuming interface structure, which is configured to cooperate with a vacuuming device to evacuate air from the thermal insulation chamber and make the thermal insulation chamber become a vacuum chamber.

### TECHNOLOGY FIELD

The present invention belongs to the field of food processing, and particularly to an oil barrel and an electric fryer having the same.

### BACKGROUND

In existing fryers (or electric fryers), oil barrels are all single-layer structures, and the materials of the oil barrels include aluminum (including tensile aluminum and cast aluminum), stainless steel, and cold-rolled plates processed by oil injection. There are plastic shells, stainless steel shells, or shells in other materials outside the oil barrels, so that a thermal insulation protective layer is formed between an oil barrel and user while the product modeling purpose is achieved. However, when an electric fryer product is normally used, the oil temperature therein may be about 200° C., and the temperature of the outside surface of the oil barrel will also be about 200° C., that is, the outside surface of the oil barrel has a problem of a too high temperature. At this time, if user touches the electric fryer inadvertently, he/she may be burned seriously and a security incident is then caused.

### SUMMARY

A purpose of the present invention is to overcome the aforesaid problems in the prior art and provide an oil barrel, which aims at solving the problem that the temperature of the outside surface of the oil barrel is too high.

The present invention is implemented as follows:

An oil barrel which is suitable for an electric fryer, the oil barrel comprises an outer shell shaped as a barrel, an inner shell shaped as a barrel disposed in a barrel cavity of the outer shell and having a distance from the outer shell, and a shell connector configured to connect the outer shell with the inner shell and connected between a lip edge of the outer shell and a lip edge of the inner shell; the outer shell, the inner shell and the shell connector cooperatively define a thermal insulation chamber; the outer shell of the oil barrel is provided with a vacuuming interface structure, which is configured to cooperate with a vacuuming device to evacuate air from the thermal insulation chamber and make the thermal insulation chamber become a vacuum chamber.

Optionally, an outside surface of the outer shell facing away from the thermal insulation chamber is coated with an appearance pattern layer.

Optionally, the oil barrel comprises a pair of handles, and the two handles are respectively disposed on the two opposite outside surfaces of the outer shell.

Optionally, the vacuuming interface structure is disposed on a bottom of the outer shell.

Optionally, the oil barrel comprises a protective masking lid configured for covering the vacuuming interface structure.

Optionally, the outer shell, the inner shell, and the shell connector are provided integrally.

Optionally, the oil barrel comprises at least three support legs connected to a bottom of the outer shell, and bottoms of the support legs are all located in a same plane.

The present invention further provides an electric fryer, the electric fryer comprises an oil barrel, a heating component and an upper cover component covering the oil barrel, the oil barrel is an oil barrel described above, the heating component includes a heating tube disposed in the barrel of a cavity of the inner shell and a control box electrically connected with the heating tube and controlling heating of the heating tube.

Optionally, the control box is fixed on the outside surface of an outer shell.

Optionally, the electric fryer comprises a frying net component, the frying net component includes a frying net configured for containing food to be fried and disposed in the barrel cavity of the inner shell, a hand shank disposed outside the oil barrel, and a frying net connector configured for connecting the frying net with the hand shank; the heating tube is arranged between the frying net and a bottom of the barrel cavity of the inner shell.

Based on the structure of the present invention, after the outer shell, the inner shell, the shell connector and the vacuuming interface structure are assembled together, a vacuuming device is used to evacuate air from the thermal insulation chamber and thereby make the thermal insulation chamber become a vacuum chamber; wherein, vacuum means an ideal state in which no substance exists, and the vacuum chamber herein means a chamber in which very little material exists. On the basis of this, and according to thermal principles, it can be known that heat conduction needs to be performed via a substance having a certain thermal conductivity. The thermal insulation chamber becomes a vacuum chamber after being evacuated by the vacuuming device, that is, by the evacuation process for the thermal insulation chamber, the heat conduction from the inner shell to the outer shell can be greatly prevented, such that an excellent heat insulation effect is provided so as to avoid a too high temperature of the outside surface of the oil barrel. The outer shell could maintain a lower temperature even during a continuous use, the safety performance of oil barrel is greatly improved, so that users can avoid being burned when touching the oil barrel accidentally, the personal safety of consumers is greatly protected, and safe and enjoyable use experience is brought to consumers. While the thermal insulation chamber provides the heat insulation function, the thermal insulation chamber can also provide a heat preservation function for hot oil in the oil barrel, so that the automatic constant-temperature time interval of the fryer having the oil barrel is lengthened, the purposes of saving electricity and conserving energy are achieved, and the fryer is more power-saving and more environment-friendly than other fryers of the same capacity and the same power.

In addition, the outside surface of the outer shell of the oil barrel has a characteristic of a low temperature. Therefore, when the oil barrel is specifically used in the fryer, the outside surface of the outer shell can be used as a decorative shell, and other outer shells does not need to be added on the outside of the oil barrel, the material cost, the mould cost, and the corresponding assembly work of these decorative shells are saved, so that the total cost of the fryer is reduced.

### BRIEF DESCRIPTION OF THE DRAWINGS

In order to illustrate the technical solutions of the embodiments of the present invention more clearly, the drawings used in the embodiments are briefly described below. It will be readily apparent that the drawings described below are only some embodiments of the present invention. For one of ordinary skill in the art, other drawings may be obtained according to these drawings on the premise of paying no creative effort.

FIG. 1 is a perspective structural schematic diagram of an oil barrel provided by a first embodiment of the present invention;

FIG. 2 is a structural schematic diagram in another view angle of FIG. 1;

FIG. 3 is a cross-sectional view of a raised oil barrel of the first embodiment one of the present invention;

FIG. 4 is an enlarged structural schematic diagram of the part A in FIG. 3;

FIG. 5 is a cross-sectional view of an oil barrel of another embodiment of the present invention;

FIG. 6 is a cross-sectional view of an electric fryer provided by a second embodiment of the present invention.

### DESCRIPTION OF REFERENCE NUMBERS

| Number | Name |
|---|---|
| 100 | Oil barrel |
| 101 | Thermal insulation chamber |
| 110 | Inner shell |
| 120 | Outer shell |
| 130 | Shell connector |
| 140 | Vacuuming interface structure |
| 150 | Handle |
| 160 | Protective masking lid |
| 170 | Support leg |
| 200 | Heating components |
| 210 | Heating tube |
| 220 | Control box |
| 300 | Upper cover component |
| 400 | Frying net components |
| 410 | Frying net |
| 420 | Hand shank |
| 430 | Frying net connector |

### Detailed Embodiments

In order to make the objectives, technical solutions and advantages of the present disclosure be clearer, the present disclosure will be further described in detail hereinafter with reference to the accompanying drawings and embodiments. It should be understood that embodiments described here are only intended to interpret the present invention but not to limit the invention.

It should be noted that when an element is referred to as being “fixed” or “disposed” to another element, it could be directly located on the other element or indirectly located on the another element. When an element is referred to as being “connected” to another element, it may be directly connected to the other element or indirectly connected to another element.

It should also be noted that the position terms in the embodiments of the present invention, such as left, right, top, bottom, and so on, are only relative concepts or take the normal using state of a product as a reference, and should not be considered as any limitation.

An embodiment of the present invention provides an oil barrel which is suitable for an electric fryer. The oil barrel is used to contain oil and heat the oil for cooking food. As used herein, the term “barrel” refers to a container having a fully or at least partially open top and which has side wall(s) and a bottom for containing frying oil to be heated. The shape of the container can be any of a number of shapes, such as a cube, rectangular cuboid, cylinder, or other shapes, with both regular and irregular shapes being suitable.

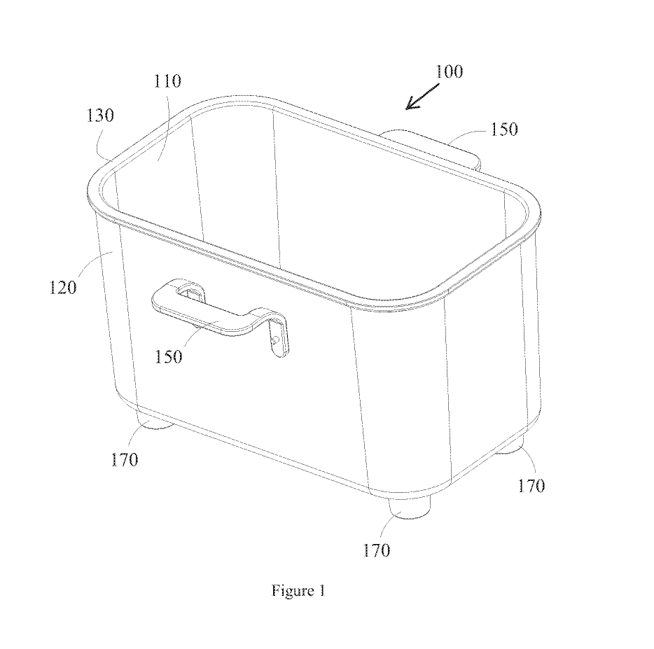

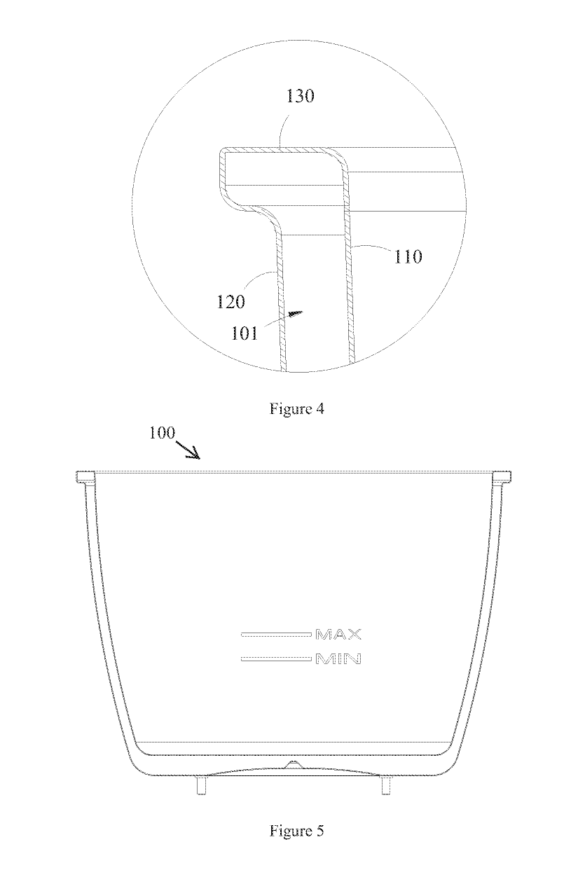

As shown in FIGS. 1 to 4, the oil barrel comprises an outer shell shaped as a barrel 120 shaped as a barrel, an inner shell 110 shaped as a barrel, disposed in the outer shell 120, and having a distance from the outer shell 120, and a shell connector 130 configured to connect the outer shell 120 with the inner shell 110 and connected between a lip edge of the outer shell 120 and a lip edge of the inner shell 110; the outer shell 120, the inner shell 110 and the shell connector 130 cooperatively define a thermal insulation chamber 101, wherein, the shell connector 130 further provides a supporting function for the inner shell 110 to prevent the inner shell 110 from falling to a bottom of a barrel cavity of the outer shell 120 under the action of the force of gravity. Particularly, in the present embodiment, the outer shell 120, the inner shell 110, and the shell connector 130 are provided integrally, in this way, it is advantageous to improve the connection strength among the outer shell 120, the inner shell 110 and the shell connector 130.

In this embodiment of the present invention, the outer shell 120 of the oil barrel 100 is provided with a vacuuming interface structure 140, which is configured to cooperate with a vacuuming device to evacuate air from the thermal insulation chamber 101 and thereby make the thermal insulation chamber 101 become a vacuum chamber. In this way, after the outer shell 120, the inner shell 110, the shell connector 130, and the vacuuming interface structure 140 are assembled together, the air in the thermal insulation chamber 101 can be evacuated by a vacuuming device, thereby making the thermal insulation chamber 101 become a vacuum chamber. By the arrangement of the outer shell, the inner shell, the shell connector and the vacuuming interface structure, the heat conduction from the inner shell to the outer shell is greatly prevented, which provides an excellent heat insulation effect to avoid a too high temperature of the outside surface of the oil barrel.

Based on the oil barrel of the present invention, after the outer shell 120, the inner shell 110, the shell connector 130, and the vacuuming interface structure 140 are assembled together, the air in the thermal insulation chamber 101 can be evacuated by a vacuuming device, and thereby make the thermal insulation chamber 101 become a vacuum chamber; wherein, vacuum means an ideal state in which no substance exists, and the vacuum chamber herein means a chamber in which very little material exists. On the basis of this and according to the thermal principles, it can be known that heat conduction needs to be performed via a substance having a certain thermal conductivity. The thermal insulation chamber 101 becomes a vacuum chamber after being evacuated by the vacuuming device, that is, by the evacuation process for the thermal insulation chamber, the heat conduction from the inner shell to the outer shell can be greatly prevented, such that an excellent heat insulation effect is provided so as to avoid a too high temperature of the outside surface of the oil barrel, the outer shell 120 could maintain a lower temperature even during a continuous use, the safety performance of oil barrels 100 is greatly improved, so that users can avoid being burned when touching the oil barrel 100 accidentally, the personal safety of consumers is greatly protected, and safe and enjoyable use experience is brought to consumers. While the thermal insulation chamber provides the heat insulation function, the thermal insulation chamber 101 can also provide a heat preservation function for hot oil in the oil barrel, so that the automatic constant-temperature time interval of the fryer having the oil barrel 100 is lengthened, the purposes of saving electricity and conserving energy are achieved, and the fryer is more power-saving and more environment-friendly than other fryers of the same capacity and the same power.

In addition, the outside surface of the outer shell 120 of the oil barrel 100 has a characteristic of a low temperature. Therefore, when the oil barrel is specifically used in the fryer, the outside surface of the outer shell 120 can be used as a decorative shell, and other outer shells does not need to be added on the outside of the oil barrel 100, the material cost, the mould cost, and the corresponding assembly work of these decorative shells are saved, so that the total cost of the fryer is reduced.

In the embodiment described above, the entire shape of the oil barrel 100 is formed as an approximate cylinder; of course, in other embodiments, the oil barrel 100 could also be formed as other shapes, as shown in FIG. 5, the entire shape of the oil barrel 100 is formed as a substantially rectangular column.

Further, an outside surface of the outer shell 120 facing away from the thermal insulation cavity 101 is coated with an appearance pattern layer (not labeled in the figures) thermal insulation, the appearance pattern layer may include using methods or matters needing attention of the fryer for indication or explanation.

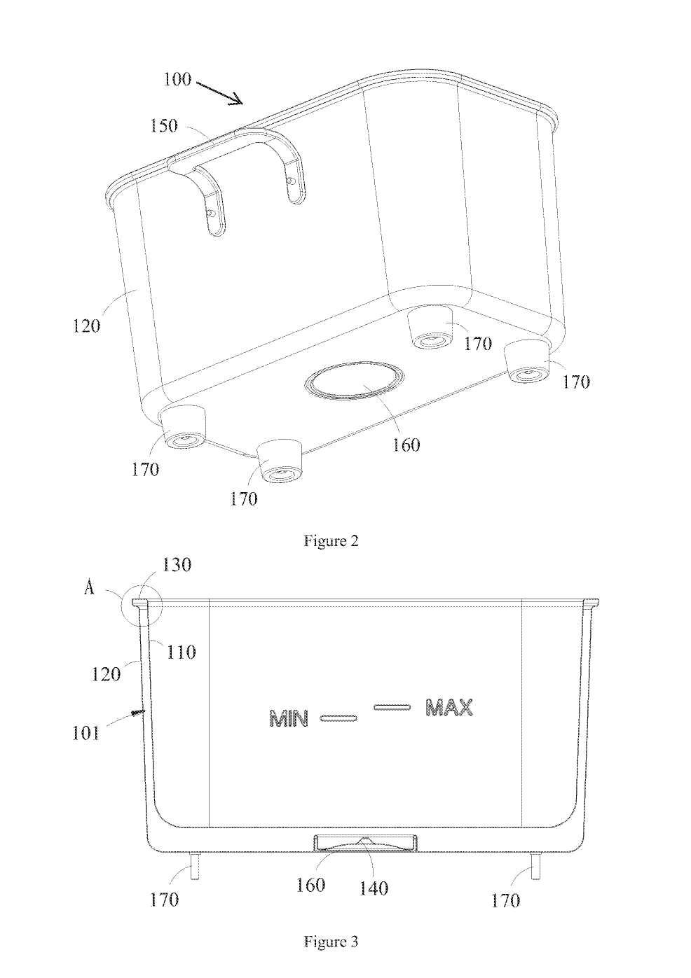

Further, as shown in FIGS. 1 and 2, the oil barrel 100 includes a pair of handles 150, and the two handles 150 are provided on two opposite outsides of the outer shell 120 respectively. In this way, a user can grab and raise the oil barrel 100 by the handles 150, such that it is easy to carry and move the oil barrel 100. Further, the handles 150 are farther from the inner shell 110 than the outer housing 120, and thus the temperature of the handles 150 is lower than the temperature of the outer shell 120, so that the temperature of the position grabbed by the user is further decreased, and the user's use experience is improved.

In the present embodiment, as shown in FIG. 2 and FIG. 3, the vacuum interface structure 140 is provided at the bottom of the outer shell 120. Based on the structures described above, since the outside surface of the outer shell 120 serves as an appearance surface of the electric fryer having the oil barrel 100, arranging the vacuum interface structure 140 at the bottom of the outer shell 120 is advantageous to prevent the vacuuming structure from deteriorating the appearance and improve the beauty of the appearance.

Further, as shown in FIGS. 2 and 3, the oil barrel 100 includes a protective masking lid 160 for covering the vacuuming interface structure 140. In this way, the vacuum interface structure 140 is covered by the protective masking lid 160, such that dust, oil, and the like are prevented from directly falling into the vacuum interface structure 140.

Further, as shown in FIGS. 1, 2 and 3, wherein, the shell of any support leg 170 is not shown in FIG. 3; the oil barrel 100 includes at least three support legs 170 connected to the bottom of the outer shell 120, and bottoms of the support legs 170 are all located in a same plane. In this way, by the arrangement of support legs 170, the outer shell 120 can be prevented from directly contacting an upholder, such as a table, so that the temperature of the outer shell 120 is prevented from affecting the upholder. Specifically, in the present embodiment, four support legs 170 are provided.

### Embodiment Two

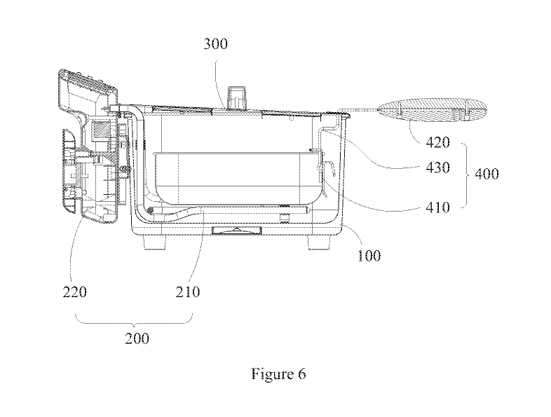

As shown in FIG. 6, the present invention further provides an electric fryer, which comprises the oil barrel 100 described above, a heating component 200, and a upper cover component 300 covering on the oil barrel 100; the heating component 200 includes a heating tube 210 disposed in the barrel cavity of the inner shell 110 (as shown in FIGS. 1 to 4), and a control box 220 electrically connected with the heating tube 210 and controlling heating of the heating tube 210. The specific structure of the oil barrel 100 is in accordance with the embodiment described above. Since the electric fryer adopts all technical solutions of the embodiment described above, it also has all the advantages brought by the technical solutions of the aforesaid embodiment and does not need to be repeated here.

Further, since the outer shell 120 (as shown in FIGS. 1 to 4) has a low temperature, the control box 220 can be directly fixed to the outside surface of the outer shell 120; based on this, directly mounting and fixing the control box 220 to the outside surface of the outer shell 120 could reduce the auxiliary connection structures, and it is beneficial to reduce components and reduce the cost.

Further, the electric fryer comprises a frying net component 400, the frying net component 400 includes a frying net 410 configured for containing food to be fried and disposed in the barrel cavity of the inner shell 110, a hand shank 420 disposed outside the oil barrel 100, and a frying net connector 430 configured for connecting the frying net 410 with the hand shank 420, the heating tube 210 is arranged between the frying net 410 and a bottom of the barrel cavity of the inner shell 110.

The above contents are only specific embodiments of the prevent invention, and are not intended to limit the prevent invention. Any modification, equivalent replacement, and improvement made within the spirit and principle of the present invention should be included within the protection scope of the present invention.

1. An oil barrel which is suitable for an electric fryer, comprising:
an outer shell shaped as a barrel;
an inner shell shaped as a barrel disposed in a barrel cavity of the outer shell and having a distance from the outer shell; and
a shell connector configured to connect the outer shell with the inner shell and which is connected between a lip edge of the outer shell and a lip edge of the inner shell,
wherein the outer shell, the inner shell and the shell connector cooperatively define a thermal insulation chamber, the outer shell of the oil barrel being provided with a vacuuming interface structure which is configured to cooperate with a vacuuming device to evacuate air from the thermal insulation chamber and make the thermal insulation chamber become a vacuum chamber.

2. The oil barrel of claim 1, wherein an outside surface of the outer shell facing away from the thermal insulation chamber is coated with an appearance pattern layer.

3. The oil barrel of claim 1, wherein the oil barrel comprises a pair of handles, and the two handles are respectively disposed on the two opposite outside surfaces of the outer shell.

4. The oil barrel of claim 1, wherein the vacuuming interface structure is disposed on a bottom of the outer shell.

5. The oil barrel of claim 4, wherein the oil barrel comprises a protective masking lid configured for covering the vacuuming interface structure.

6. The oil barrel of claim 1, wherein the outer shell, the inner shell, and the shell connector are provided integrally.

7. The oil barrel of claim 1, wherein the oil barrel comprises at least three support legs connected to a bottom of the outer shell, and bottoms of the support leg are all located in a same plane.

8. An electric fryer comprising an oil barrel, a heating component and an upper cover component covering the oil barrel, wherein the oil barrel is the oil barrel of claim 1, and wherein the heating component includes a heating tube disposed in a barrel cavity of the inner shell and a control box electrically connected with the heating tube and controlling heating of the heating tube.

9. The electric fryer of claim 8, wherein the control box is fixed on an outside surface of the outer shell.

10. The electric fryer of claim 8, further comprising a frying net component, the frying net component including a frying net configured for containing food to be fried which is disposed in the barrel cavity of the inner shell, a hand shank disposed outside the oil barrel, and a frying net connector configured for connecting the frying net with the hand shank, wherein the heating tube is arranged between the frying net and a bottom of the barrel cavity of the inner shell.
